(19) United States
(12) Patent Application Publication
(10) Pub. No.: US 2023/0112622 A1
(43) Pub. Date: Apr. 13, 2023

(54) Voice Authentication Apparatus Using Watermark Embedding And Method Thereof

(71) Applicant: PUZZLE AI CO., LTD., Seoul (KR)

(72) Inventor: Ha Rin JUN, Daejeon (KR)

(73) Assignee: PUZZLE AI CO., LTD., Seoul (KR)

(21) Appl. No.: 17/909,503

(22) PCT Filed: Jul. 17, 2020
(86) PCT No.: PCT/KR2020/009436

§ 371 Date: Sep. 6, 2022

(30) Foreign Application Priority Data
Mar. 9, 2020 (KR) 10-2020-0028774

(51) Int. Cl. G10L 17/08; G10L 17/02; G10L 19/018; G10L 17/18; G10L 17/04; G10L 25/18; G06T 7/90; G06F 21/32

(52) U.S. Cl. CPC G10L 17/08; G10L 17/02; G10L 19/018; G10L 17/18; G10L 17/04; G10L 25/18; G06T 7/90; G06F 21/32

(57) ABSTRACT

The present disclosure provides a voice authentication system. The voice authentication system according to an embodiment of the present disclosure includes a voice collection unit configured to collect voice information obtained by digitizing a speaker's voice, a learning model server configured to generate a voice image based on the collected voice information of the speaker, causes a deep neural network (DNN) model to learn the voice image, and extract a feature vector for the voice image, a watermark server configured to generate a watermark based on the feature vector and embed the watermark and individual information into the voice image or voice conversion data, and an authentication server configured to generate a private key based on the feature vector and determine whether to extract the watermark and the individual information based on an authentication result.

### TECHNICAL FIELD

The present disclosure relates to a voice authentication system and method, and more particularly, to a voice authentication system and method having enhanced security by embedding a watermark.

### BACKGROUND

Bio-authentication refers to a technology that identifies and authenticates a user based on body information that cannot be imitated by others. Among various bio-authentication technologies, recently, research on voice recognition technology is being actively conducted. The voice recognition technology is largely divided into ‘speech recognition’ and ‘speaker authentication’. The speech recognition is to understand the ‘content’ spoken by unspecified individuals regardless of who is speaking, whereas the speaker authentication is to distinguish ‘who’ is telling the story.

As an example of the speaker authentication technology, there is a ‘voice authentication service’. If it is possible to accurately and quickly identify the subject of ‘who’ with only voice, it will be possible to provide convenience to users by reducing cumbersome steps, such as entering a password after logging in and verifying a public certificate, from the existing methods required for personal authentication in various fields.

In this case, in the speaker authentication technology, after registering a user's voice for the first time, a voice uttered by the user and the registered voice are compared every time an authentication request is made, and authentication is performed based on whether or not they match. When a user registers a voice, feature points may be extracted from voice data on a few seconds (e.g., 10 sec) basis. The feature points may be extracted in various types such as intonation and speech speed, and users may be identified by a combination of these features.

However, when a registered user registers or authenticates his/her voice, there may occur a situation in which a third party located nearby records the registered user's voice without permission and attempts to authenticate the speaker with the recorded file, so the security of the speaker authentication technology may be an issue. If such a situation occurs, it may cause huge damage to the user, and the reliability of speaker authentication may inevitably be lowered. That is, the effectiveness of the speaker authentication technology may deteriorate, and forgery or falsification of voice authentication data may frequently occur.

To solve this problem, the speaker authentication technology may perform authentication by calculating the similarity between the previously learned voice data model of the registered user and the voice data of a third party, and in particular, a deep neural network may be used for a learning model.

In addition, a technology for creating and modifying medical records by authenticating with biometric information has been recently developed for medical record security in an integrated medical management system. In other words, a security technology applying a biometric-based authentication model has been developed for patients and medical personnel accessing electronic medical records.

However, there is still a need for security technology and model that can support, in the exchange of personal health/medical information, transmitting and receiving only available information safely between authorized domains, and restrict access to electronic medical records.

In addition, since there is a security problem and possibility of hacking in the process of creating and transmitting medical records and advisory data, there is a problem in that the medical records can be forged in the event of a medical accident.

### Documents of Related Art

### Patent Document

Korean Registered Patent Publication No. 10-1925322

### SUMMARY

In order to solve the above problems, the present disclosure provides a voice authentication system in which only a designated user (speaker) can access and modify corresponding medical information through voice authentication with improved accuracy.

In addition, the integrity of voice authentication data may be secured through an authentication technique by watermark embedment.

The problems to be solved by the present disclosure are not limited to those mentioned above, and other problems not mentioned will be clearly understood by those skilled in the art from the following description.

A voice authentication system according to an embodiment of the present disclosure for achieving the above object includes: a voice collection unit configured to collect voice information obtained by digitizing a speaker's voice; a learning model server configured to generate a voice image based on the collected voice information of the speaker, cause a deep neural network (DNN) model to learn the voice image, and extract a feature vector for the voice image or voice conversion data; a watermark server configured to generate a watermark based on the feature vector and embed the watermark and individual information into the voice image; and an authentication server configured to generate a private key based on the feature vector and determine whether to extract the watermark and the individual information based on an authentication result.

In addition, the learning model server may include: a frame generation unit configured to generate a voice frame for a predetermined time based on the voice information; a frequency analysis unit configured to analyze a voice frequency based on the voice frame, and generate the voice image in time series by imaging the voice frequency; and a neural network learning unit configured to extract the feature vector by causing the deep neural network model to learn the voice image.

In addition, the watermark server may include: a watermark generation unit configured to generate and store the watermark corresponding to the feature vector; a watermark embedment unit configured to embed the generated watermark and the individual information into a pixel of the voice image or the voice conversion data; and a watermark extraction unit configured to extract the pre-stored watermark and the individual information based on the authentication result for the speaker.

In addition, the authentication server may include: an encryption generation unit configured to encrypt the feature vector to generate the private key corresponding to the feature vector; an authentication comparison unit configured to compare the sameness between the encrypted feature vector and a feature vector of an authentication target; and an authentication determination unit configured to determine whether authentication is successful for the speaker based on a comparison result, and determines whether to extract the watermark and the individual information.

A voice authentication method according to an embodiment of the present disclosure includes: a voice collection step of collecting voice information obtained by digitizing a speaker's voice; a learning model step of generating a voice image based on the collected voice information of the speaker, causing a deep neural network (DNN) model to learn the voice image, and extracting a feature vector for the voice image; an encryption generation step of encrypting the feature vector to generate a private key corresponding to the feature vector; a watermark generation step of generating and storing a watermark and individual information based on the private key; a watermark embedment step of embedding the watermark and the individual information into a pixel of the voice image or voice conversion data; an authentication comparison step of comparing the sameness between the encrypted feature vector and a feature vector of an authentication target; an authentication determination step of determining whether authentication is successful for the speaker based on a comparison result, and determining whether to extract the watermark and the individual information; and a watermark extraction step of extracting the watermark and the individual information that have been pre-stored based on an authentication result.

In addition, the learning model step may include: a frame generation step of generating a voice frame for a predetermined time based on the voice information; a frequency analysis step of analyzing a voice frequency based on the voice frame, and generating the voice image in time series by imaging the voice frequency; a neural network learning step of causing the deep neural network model to learn the voice image; and a feature vector extraction step of extracting the feature vector of the learned voice image.

Other specific details of the present disclosure are included in the detailed description and drawings.

According to the present disclosure, access, forgery, and falsification by unauthorized persons using speaker's voice information are impossible since security is enhanced.

In addition, since the deep neural network model is used, the accuracy of speaker's voice authentication may be improved.

### BRIEF DESCRIPTION OF DRAWINGS

FIG. 1 is a block diagram of a voice authentication system according to an embodiment of the present disclosure.

FIG. 2 is a block diagram of a learning model server in a voice authentication system according to an embodiment of the present disclosure.

FIG. 3 is a block diagram of a watermark server in a voice authentication system according to an embodiment of the present disclosure.

FIG. 4 is a block diagram of an authentication server in a voice authentication system according to an embodiment of the present disclosure.

FIG. 5 is a flowchart illustrating a flow of a voice authentication method according to an embodiment of the present disclosure.

FIG. 6 is a flowchart illustrating an operation flow for a learning model step of a voice authentication method according to an embodiment of the present disclosure.

FIG. 7 is a diagram illustrating an example of extracting a feature vector (D-vector) in a learning model server of a voice authentication system according to an embodiment of the present disclosure.

FIG. 8 is a diagram illustrating an example of generating a voice image in a learning model server of a voice authentication system according to an embodiment of the present disclosure.

FIG. 9 is a diagram illustrating an example of voice conversion data converted into a multidimensional array by a watermark embedment unit of a voice authentication system according to an embodiment of the present disclosure.

### DETAILED DESCRIPTION

Hereinafter, preferred embodiments of the present disclosure will be described in detail with reference to the accompanying drawings. Advantages and features of the present disclosure, and a method of achieving them will become apparent with reference to the embodiments described below in detail in conjunction with the accompanying drawings. However, the present disclosure is not limited to the embodiments disclosed below, but will be implemented in a variety of different forms. The present embodiments are only provided to complete the disclosure of the present invention, and to fully inform those of ordinary skill in the art to which the present disclosure pertains of the scope of the invention, and the present disclosure is only defined by the scope of the claims. Like reference numerals refer to like elements throughout the specification.

Although first, second, and the like are used to describe various elements, components, and/or sections, it should be understood that these elements, components, and/or sections are not limited by their terms. These terms are only used to distinguish one element, component, or section from another element, component, or section. Therefore, it goes without saying that a first element, a first component, or a first section mentioned below may be a second element, a second component, or a second section within the technical idea of the present disclosure.

The terminology used herein is for the purpose of describing the embodiments and is not intended to limit the present disclosure. In this specification, the singular also includes the plural, unless specifically stated otherwise in the phrase. As used herein, a component, step, operation, and/or element referring to “comprise” and/or “made of” do not exclude the presence or addition of one or more other components, steps, operations and/or elements.

Unless otherwise defined, all terms (including technical and scientific terms) used herein may be used in the meaning that can be commonly understood by those of ordinary skill in the art to which the present disclosure pertains. In addition, commonly used terms defined in the dictionary are not to be interpreted ideally or excessively unless clearly defined in particular.

In this case, the same reference numerals refer to the same elements throughout the specification, and it will be understood that each configuration of the process flow diagrams and combinations of the flow diagrams may be performed by computer program instructions. These computer program instructions may be embodied in a processor of a general purpose computer, special purpose computer, or other programmable data processing equipment, so that the instructions executed through the processor of the computer or other programmable data processing equipment may create means for performing the functions described in the flow diagram configuration(s).

It should also be noted that in some alternative embodiments, it is also possible for the functions recited in the configurations to occur out of order. For example, two configurations shown one after another may in fact be performed substantially simultaneously, or the configurations may sometimes be performed in the reverse order according to the corresponding function.

Hereinafter, the present disclosure will be described in more detail with reference to the accompanying drawings.

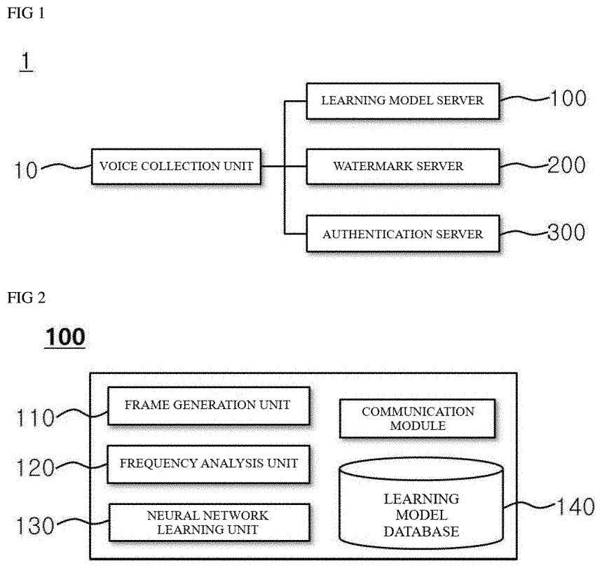

FIG. 1 is a block diagram of a voice authentication system 1 according to an embodiment of the present disclosure.

Referring to FIG. 1, the voice authentication system 1 includes a voice collection unit 10, a learning model server 100, a watermark server 200, and an authentication server 300.

Specifically, the voice authentication system 1 according to the present disclosure includes the voice collection unit 10 that collects voice information obtained by digitizing a speaker's voice, the learning model server 100 that generates a voice image based on the collected voice information of the speaker, causes a deep neural network (DNN) model to learn the voice image, and extracts a feature vector for the voice image or voice conversion data, the watermark server 200 that generates a watermark based on the feature vector and embeds the watermark and individual information into the voice image, and the authentication server 300 that generates a private key based on the feature vector and determines whether to extract the watermark and the individual information based on an authentication result.

Here, the voice information may be generated by A/D modulating the speaker's voice, which is an analog signal, through a pulse code modulation (PCM) process that is divided into three steps, such as sampling, quantizing, and encoding.

The individual information is medical information including at least one of a medical code, patient personal information, and medical record information corresponding to the feature vector, and may be in the form of text.

Therefore, by applying the voice authentication system 1 according to an embodiment of the present disclosure to an integrated medical management system, it is possible to prevent hacking problems that may occur when creating and transmitting medical records, and to prevent forgery of medical records when a medical accident occurs.

In addition, the voice collection unit 10 may include any wired or wireless home appliance/communication terminal having a display module, and may be an information communication device such as a computer, a laptop, or a tablet PC in addition to a mobile communication terminal, or a device including the same.

In this case, the display module of the voice collection unit 10 may output a voice authentication result, may include at least one of a liquid crystal display (LCD), a thin film transistor-liquid crystal display (TFT LCD), an organic light emitting diode (OLED), a flexible display, a 3D display, an e-ink display, and a transparent organic light emitting diode (TOLED), and when the display module is a touch screen, various information may be outputted simultaneously with voice input.

In addition, each of the learning model server 100, the watermark server 200, and the authentication server 300 is accessible through a communication network, and the communication network may include a local area network (LAN), a metropolitan area network (MAN), a wide area network (WAN), the Internet, 2G, 3G, and 4G mobile communication networks, Wi-Fi, wireless broadband (Wibro), and the like, and also includes a wired network as well as a wireless network. Examples of such a communication network include the Internet and the like. A wireless LAN (WLAN) (Wi-Fi), Wibro, a world interoperability for microwave access (Wimax), a high speed downlink packet access (HSDPA), or the like may be used as the wireless network.

Hereinafter, detailed configurations and functions of the learning model server 100, the watermark server 200, and the authentication server 300 of the voice authentication system 1 according to an embodiment of the present disclosure will be described in detail.

FIG. 2 is a block diagram of the learning model server 100 in the voice authentication system 1 according to an embodiment of the present disclosure.

Referring to FIG. 2, the learning model server 100 may include a frame generation unit 110 for generating a voice frame for a predetermined time based on the voice information, a frequency analysis unit 120 for analyzing a voice frequency based on the voice frame, and generating the voice image in time series by imaging the voice frequency, and a neural network learning unit 130 for extracting the feature vector by causing the deep neural network model to learn the voice image.

In a conventional voice recognition technology, one phoneme is found by collecting continuous voice frames for a period of 0.5 seconds (800 frames) to 1 second (16,000 frames). Accordingly, the frame generation unit 110 generates the voice frame for the digitized voice information, and determines the number of frames according to a sampling rate, which means the ratio of the number of samples per second. Here, the unit is hertz (Hz), and 16,000 voice frames having a frequency of 16,000 Hz may be secured.

In addition, it is desirable that the frequency analysis unit 120 generates the voice image by applying the voice frame generated by the frame generation unit 110 to a short time Fourier transform (STFT) algorithm.

Here, the STFT algorithm is an algorithm that is easy to restore, and an algorithm that analyzes time series data by frequency for each time period to output it.

Accordingly, the frequency analysis unit 120 may input the voice frame generated based on voice information for a predetermined time to the STFT algorithm, thereby outputting it as an image in which the horizontal axis represents a time axis, the vertical axis represents a frequency, and each pixel represents the intensity information of each frequency.

In addition, the frequency analysis unit 120 may use a feature extraction algorithm of Mel-Spectrogram, Mel-filterbank, or Mel-frequency cepstral coefficient (MFCC) as well as the STFT algorithm to generate a spectrogram which is the voice image.

The deep neural network (DNN) model of the neural network learning unit 130 preferably includes, but is not limited to, a long short term memory (LSTM) neural network model, and the feature vector is preferably a D-vector.

In this case, the neural network learning unit 130 may be trained through a convolutional neural network (CNN) that mimics the optic nerve structure among several series of the deep neural network (DNN) model, a time-delay neural network (TDNN) specialized in data processing by giving different weights to the current input signal and the past input signals, a long short-term memory (LSTM) model that is robust to the long-term dependency problem of time series data, and the like, but it will be apparent to those skilled in the art that the present disclosure is not limited thereto.

The deep neural network (DNN) model may extract a feature vector that is a characteristic of the speaker's voice from the voice image. At this time, in the process of learning the voice image, a hidden layer of the deep neural network model may be transformed according to the inputted feature, and the outputted feature vector may be optimized and processed to be able to identify the speaker.

In particular, the deep neural network (DNN) model may be a special kind of LSTM neural network model that can learn long-term dependencies. Since the LSTM neural network model is a type of recurrent neural network (RNN), it is mainly used to extract time-series correlations of input data.

In addition, the D-vector, which is the feature vector, is extracted from the deep neural network (DNN) model, and in particular, is a feature vector of the recurrent neural network (RNN), which is a type of deep neural network (DNN) model for time series data, and may express the characteristics of a speaker with a specific vocalization.

In other words, the neural network learning unit 130 inputs the voice image to a hidden layer of the LSTM neural network model and outputs the D-vector, which is the feature vector.

At this time, the D-vector is preferably processed in a matrix or array form of a combination of hexadecimal alphabets and numbers, and may be processed in the form of a universal unique identifier (UUID), which is an identifier standard used for software construction. Here, the UUID is an identifier standard having characteristics that do not overlap between identifiers, and may be an identifier optimized for a speaker's voice identification.

A learning model database 140 may store information received from the voice collection unit 10, the watermark server 200, and the authentication server 300 through a communication module, and means a logical or physical storage server that stores a voice image, a D-vector, and the like corresponding to the voice information of a designated speaker.

Here, the learning model database 140 may be in the form of Oracle DBMS of Oracle, MS-SQL DBMS of Microsoft, SYBASE DBMS of Sybase, or the like, but it will be apparent to those skilled in the art that the present disclosure is not limited thereto.

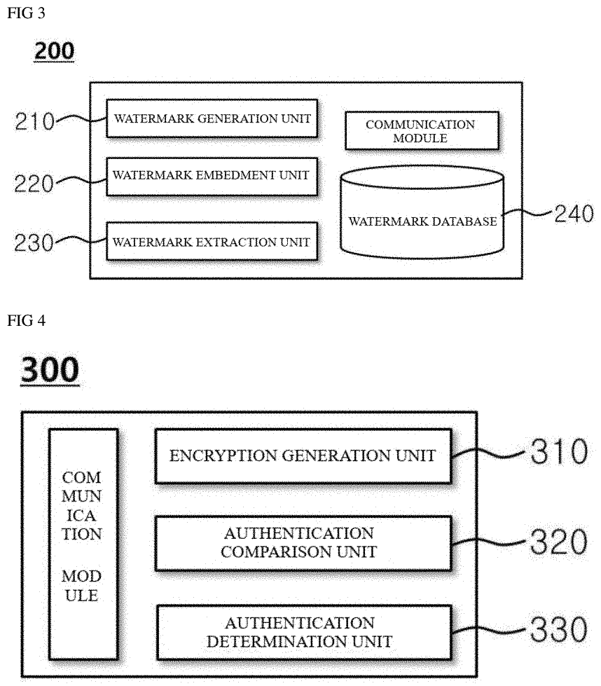

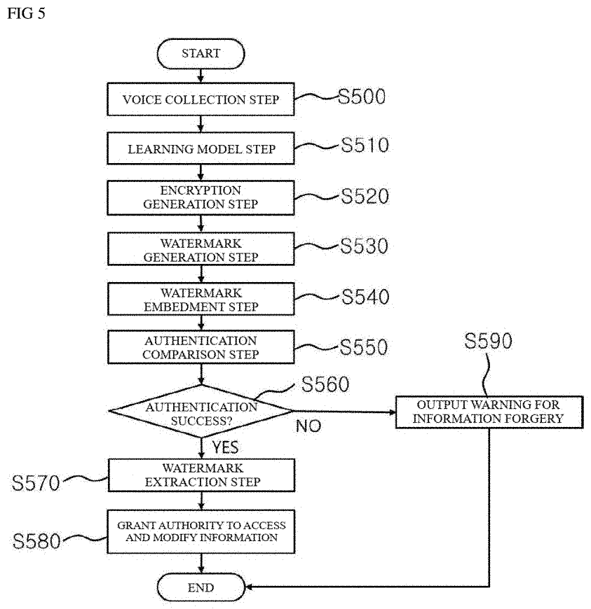

FIG. 3 is a block diagram of the watermark server 200 in the voice authentication system 1 according to an embodiment of the present disclosure. FIG. 4 is a block diagram of the authentication server 300 in the voice authentication system 1 according to an embodiment of the present disclosure.

Referring to FIG. 3, the watermark server 200 may include a watermark generation unit 210 for generating and storing the watermark based on the private key corresponding to the feature vector, a watermark embedment unit 220 for embedding the generated watermark and the individual information into a pixel of the voice image or the voice conversion data, and a watermark extraction unit 230 for extracting the pre-stored watermark and the individual information based on the authentication result for the speaker.

Specifically, the watermark generation unit 210 may generate a watermark pattern corresponding to the feature vector extracted from the learning model server 100 and/or corresponding to the private key generated by the authentication server 300, received through the communication module, and may store the feature vector, the private key, and the generated watermark pattern in a watermark database 240. Here, the private key is generated in the authentication server 300 by encrypting the feature vector extracted from the learning model server 100.

Here, the watermark database 240 may be in the form of Oracle DBMS of Oracle, MS-SQL DBMS of Microsoft, SYBASE DBMS of Sybase, or the like, but it will be apparent to those skilled in the art that the present disclosure is not limited thereto.

The generated watermark and the individual information may be encrypted and decrypted by applying an encryption algorithm, e.g., advanced encryption standard (AES) thereto. The AES is a standard symmetric key encryption method used by government agencies to maintain security for materials that is sensitive but not classified.

The watermark embedment unit 220 may extract an RGB value for each pixel of the voice image, calculate the difference between the RGB value and a total average RGB value, and may embed the watermark and the individual information into a pixel whose calculated difference is less than a threshold value.

In other words, it is preferable to select a pixel having a relatively small difference value among the extracted RGB values compared to the average RGB value of the entire image and having less color modulation and embed the watermark and the individual information into the pixel.

That is, the selected pixel has low importance for the voice image identification, and the watermark pattern to be repeatedly arranged may be embedded into the pixel. At this time, the individual information is inputted to the pixel together with the watermark pattern, and the individual information is preferably medical information including at least one of a medical code, patient personal information, and medical record information corresponding to the feature vector, and may be in the form of text.

On the other hand, the watermark embedment unit 220 may receive from the voice collection unit 10 the voice information obtained by digitizing the speaker's voice and convert it into a multidimensional array to acquire the voice conversion data, and may embed the watermark and the individual information into a least significant bit (LSB) of the voice conversion data.

Here, the voice conversion data is a converted value acquired by arranging the voice information in a specific multi-dimension that is variable, and it is preferable to embed the watermark and the individual information into an LSB of the converted value, but the watermark and the individual information may be embedded into a most significant bit (MSB) of the converted value.

In this case, the watermark embedment unit 220 may embed the watermark by using a transform method such as discrete Fourier transform (DFT), discrete cosine transform (DCT), or discrete wavelet transform (DWT), as a method of changing the frequency coefficient.

This method prevents, when the watermark is embedded or compressed for transmission or storage, the watermarked data from being broken and enables data extraction in spite of noise or various types of deformation and attacks that may occur during transmission.

That is, by embedding the watermark and the individual information into the voice conversion data for the voice information as well as each pixel of the voice image, robustness against forgery and falsification of the original voice data, which is the speaker's actual voice, may be improved.

Referring to FIG. 4, the authentication server 300 may include an encryption generation unit 310 for generating the private key by encrypting the feature vector, an authentication comparison unit 320 for comparing the sameness between the encrypted feature vector and a feature vector of an authentication target, and an authentication determination unit 330 for determining whether authentication is successful for the speaker based on the comparison result, and determining whether to extract the watermark and the individual information.

The encryption generation unit 310 performs encryption based on the D-vector (feature vector) received from the learning model server 100, and may use a transform algorithm to create the private key corresponding thereto.

If this is applied to the integrated medical management system, the private key may be a key encrypted with the voice of a patient, nurse, or doctor.

In addition, the encryption generation unit 310 transmits the created private key to the watermark generation unit 210 of the watermark server 200 to generate the watermark based on the private key.

For example, when an outsider who is not registered in the voice authentication system 1 acquires a partial voice of a registered speaker and attempts to access and change information corresponding to the partial voice information, since the partial voice acquired by the encryption generation unit 310 cannot be decrypted by a symmetric key algorithm, a parity bit cannot be generated.

That is, since the private key cannot be generated, the watermark is not generated in the watermark generation unit 210 and is broken, and thus an outsider access warning may be outputted.

In addition, the authentication comparison unit 320 may compare the sameness by applying the feature vector to an edit distance algorithm. Here, the edit distance algorithm is an algorithm that calculates the similarity between two character strings. Since the criterion for judging the similarity is the number of insertions/deletions/changes performed at the time of string comparison, the result of the edit distance algorithm may be the similarity of a matrix or arrangement between feature vectors corresponding to two or more pieces of collected voice information.

When it is determined that the encrypted feature vector and the feature vector of the authentication target are identical based on the result of the edit distance algorithm, the authentication determination unit 330 may determine that authentication is successful. On the other hand, when it is determined that the encrypted feature vector and the feature vector of the authentication target are not identical, the authentication determination unit 330 may determine that authentication has failed.

Therefore, when the authentication is successful, the authentication determination unit 330 may grant access and modification authority to the extracted voice information and individual information, and when the authentication fails, the authentication determination unit 330 may output a warning signal for information 5 forgery.

As described above, the present disclosure may provide the voice authentication system 1 that causes only a designated user (speaker) to access and modify corresponding medical information through voice authentication with improved accuracy, and may secure the integrity of voice authentication data through an authentication technique by watermark embedment.

FIG. 5 is a flowchart illustrating a flow of a voice authentication method according to an embodiment of the present disclosure.

Referring to FIG. 5, the voice authentication method according to the present disclosure may include a voice collection step of collecting voice information obtained by digitizing a speaker's voice (step S500), a learning model step of generating a voice image based on the collected voice information of the speaker, causing a deep neural network model to learn the voice image, and extracting a feature vector for the voice image (step S510), a encryption generation step of encrypting the feature vector to generate a private key corresponding to the feature vector (step S520), a watermark generation step of generating and storing a watermark and individual information based on the private key (step S530), and a watermark embedment step of embedding the generated watermark and individual information into a pixel of the voice image or voice conversion data (step S540), an authentication comparison step of comparing the sameness between the encrypted feature vector and a feature vector of an authentication target (step S550), an authentication determination step of determining whether authentication is successful for the speaker based on the comparison result, and determining whether to extract the watermark and the individual information (step S560), and a watermark extraction step of extracting the watermark and the individual information that have been pre-stored based on the authentication result (step S570).

In addition, the voice authentication method may further include an authorization step of, when the authentication is successful, granting access and modification authority to the extracted voice information and individual information (step S580), and a forgery warning step of, when the authentication fails, outputting a warning signal for information forgery (step S590).

Specifically, when a user registered in the voice authentication system 1 inputs an ID and a password (PW) and simultaneously inputs a voice through the voice collection unit 10 (step S500), a spectrogram, which is a voice image, is generated based on the user's voice information collected in the voice collection unit 10, and a D-vector, which is a feature vector of the spectrogram, is extracted (step S510).

Then, the encryption generation unit 310 of the authentication server 300 encrypts the D-vector of the user through a symmetric key algorithm to create a private key (step S520), and the watermark generation unit 210 of the watermark server 200 generates a watermark based on the private key (step S530). At the same time as generating the watermark, the private key is decrypted to check whether authentication of the ID and the PW is successful. If the authentication is successful, the user is caused to access the voice authentication system 1.

Thereafter, the watermark embedment unit 220 of the watermark server 200 embeds the watermark and individual information into a pixel of the spectrogram (step S540), wherein the pixel is a least significant bit (LSB).

Alternatively, the watermark embedment unit 220 embeds the watermark and the individual information into a least significant bit (LSB) of voice conversion data acquired by converting the voice information, which is obtained by digitizing the speaker's voice, received from the voice collection unit 10 into a multidimensional array (step S540).

Next, the authentication comparison unit 320 of the authentication server 300 compares whether a D-vector previously stored in the voice authentication system 1 and the D-vector extracted from the user's voice are identical (step S550).

At this time, the authentication comparison unit 320 may compare whether the D-vectors are identical by calculating the similarity between the D-vectors using the edit distance algorithm.

If the D-vectors are identical, the authentication determination unit 330 of the authentication server 300 determines it as ‘authentication success’. On the other hand, if the D-vectors are not identical, the authentication determination unit 330 determines it as ‘authentication failure’ (step S560).

In the case of ‘authentication success’, the watermark extraction unit 230 of the watermark server 200 extracts a watermark of the spectrogram (step S570), and decrypts the extracted watermark to grant the user the authority to access and modify his/her information previously stored in the voice authentication system 1 (step S580).

On the other hand, in the case of ‘authentication failure’, the watermark extraction unit 230 may refuse the user's access and output a warning about the risk of forgery of the pre-stored information (step S590).

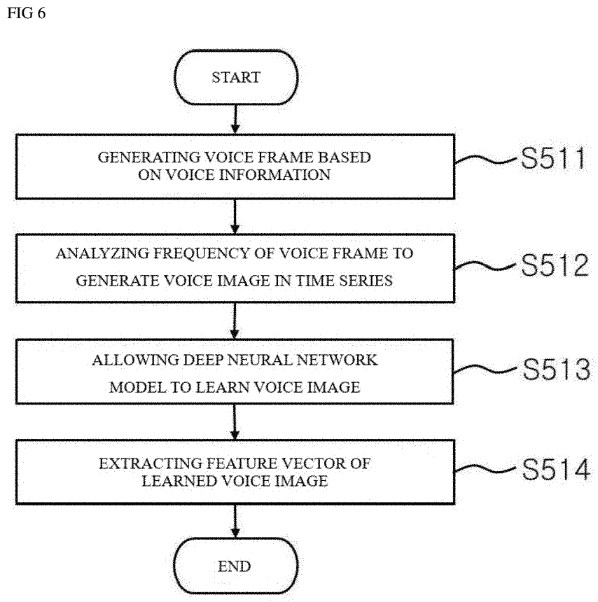

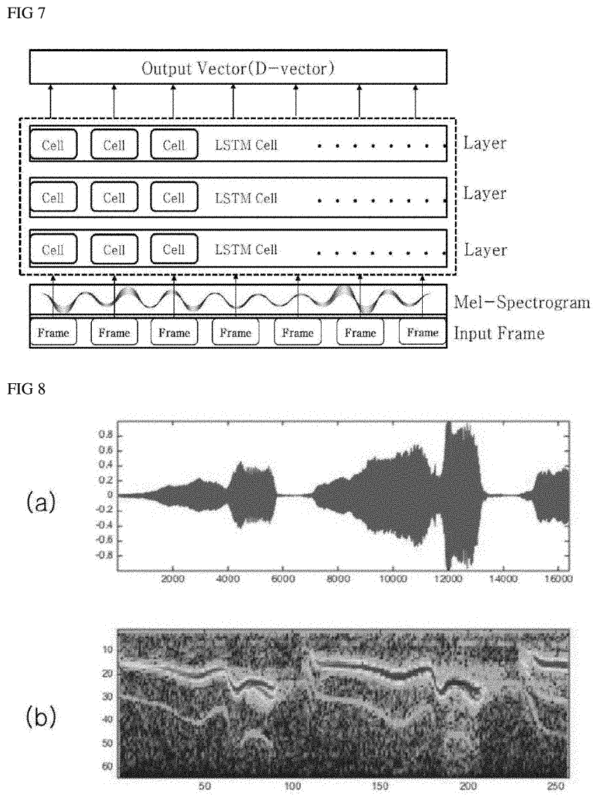

FIG. 6 is a flowchart illustrating an operation flow for a learning model step of a voice authentication method according to an embodiment of the present disclosure. FIG. 7 is a diagram illustrating an example of extracting a feature vector (D-vector) in the learning model server 100 of the voice authentication system 1 according to an embodiment of the present disclosure.

Referring to FIG. 6, the learning model step S510 may include a frame generation step of generating a voice frame for a predetermined time based on the voice information (step S511), a frequency analysis step of analyzing a voice frequency based on the voice frame, and generating the voice image in time series by imaging the voice frequency (step S512), a neural network learning step of causing the deep neural network model to learn the voice image (step S513), and a feature vector extraction step of extracting the feature vector of the learned voice image (step S514).

Details of the learning model step S510 will be described with reference to FIG. 7.

As shown in FIG. 7, the spectrogram as the voice image is generated by applying the voice frame, which is an input frame, to Mel-Spectrogram.

Then, the LSTM model, which is the deep neural network (DNN) model, is caused to learn the spectrogram in three hidden layers thereof.

In this case, the hidden layers of the LSTM model has the function of preserving past memories to prevent the reflection of the initial time period from converging to zero, but deleting the memories that are no longer needed.

As the learning result, an output vector, i.e., the D-vector, which is the feature vector, is extracted.

In other words, the spectrogram is generated by converting the voice frame, and the spectrogram is inputted to the hidden layer of the LSTM neural network model to output the D-vector.

FIG. 8 shows an example of generating a voice image in the learning model server 100 of the voice authentication system 1 according to an embodiment of the present disclosure.

In FIG. 8, (a) is a diagram showing a voice frame, and (b) is a diagram illustrating a voice image which is a spectrogram.

In other words, as shown in (a) of FIG. 8, the digitized voice information is generated as the voice frame, and the number of frames is determined according to the sampling rate, which means the ratio of the number of samples per second.

Then, as shown in (b) of FIG. 8, the voice image is generated by applying the voice frame to a short time Fourier transform (STFT) algorithm.

That is, by inputting the voice frame generated based on the voice information for a predetermined time into the STFT algorithm, the voice image as shown in (b) may be outputted in which the horizontal axis represents a time axis, the vertical axis represents a frequency, and each pixel represents the intensity information of each frequency.

In addition, the spectrogram, which is the voice image, may be generated by using a feature extraction algorithm of Mel-spectrogram, Mel-filterbank, or Mel-frequency cepstral coefficient (MFCC) as well as the STFT algorithm.

That is, in the image of (b) of FIG. 8, the watermark and the individual information, which is medical information, may be embedded into a pixel with a low RGB value and low color modulation, i.e., a pixel with low importance for identification.

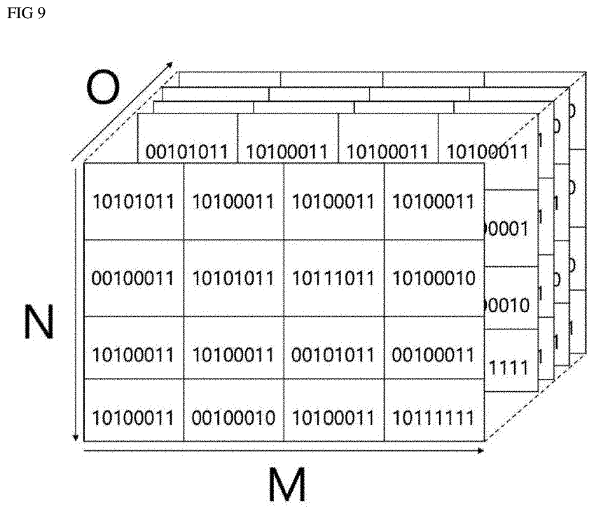

FIG. 9 is a diagram illustrating an example of voice conversion data converted into a multidimensional array by the watermark embedment unit 220 of the voice authentication system 1 according to an embodiment of the present disclosure.

As shown in FIG. 9, the watermark embedment unit 220 may convert the voice information obtained by digitizing the speaker's voice into a multidimensional array.

Here, the voice conversion data is a converted value obtained by arranging the voice information in a specific multidimensional array MxNxO that is variable, and the watermark and the individual information may be embedded into an LSB of the converted value. Alternatively, the watermark and the individual information may be embedded into an MSB of the converted value.

As described above, in the watermarked voice authentication system and the method therefor according to the present disclosure, access, forgery, and falsification by unauthorized persons using speaker's voice information are impossible since security is enhanced. In addition, since the deep neural network model is used, the accuracy of the speaker's voice authentication may be improved.

On the other hand, the voice authentication system according to an embodiment of the present disclosure may be implemented with a single module by software and hardware, and the above-described embodiments of the present disclosure may be written using a program that can be executed on a computer, and may be implemented in a general-purpose computer that operates the program using a computer-readable recording medium. The computer-readable recording medium is implemented in the form of a magnetic medium such as a ROM, a floppy disk, or a hard disk, an optical medium such as a CD or a DVD, or a carrier wave such as transmission through the Internet. In addition, the computer-readable recording medium is distributed in a computer system connected through a network, so that a computer-readable code may be stored and executed in a distributed manner.

In addition, a component or a ‘—module’ used in an embodiment of the present disclosure may be implemented with software such as a task, a class, a subroutine, a process, an objects, an execution thread, or a program performed in a predetermined area on a memory, or hardware such as a field-programmable gate array (FPGA) or an application-specific integrated circuit (ASIC). Alternatively, it may be formed of a combination of the software and the hardware. The component or the ‘— module’ may be included in a computer-readable storage medium, or a part thereof may be distributed in a plurality of computers.

Although the embodiments of the present disclosure have been described above with reference to the accompanying drawings, those of ordinary skill in the art to which the present disclosure pertains will understand that the present disclosure may be implemented in other specific forms without changing the technical idea or essential features thereof. Therefore, it should be understood that the embodiments described above are illustrative in all respects and not restrictive.

[Reference Sign List]

| | |
|---|---|
| 1: voice authentication system | 10: voice collection unit |
| 100: learning model server | 110: frame generation unit |
| 120: frequency analysis unit | 130: neural network learning unit |
| 140: learning model database | 200: watermark server |
| 210: watermark generation unit | 220: watermark embedment unit |
| 230: watermark extraction unit | 240: watermark database |
| 300: authentication server | 310: encryption generation unit |
| 320: authentication comparison unit | 330: authentication determination |
| | unit |

What is claimed is:

1. A voice authentication system comprising:
a voice collection unit configured to collect voice information obtained by digitizing a speaker's voice;
a learning model server configured to generate a voice image based on the collected voice information of the speaker, cause a deep neural network (DNN) model to learn the voice image, and extract a feature vector for the voice image;
a watermark server configured to generate a watermark based on the feature vector and embed the watermark and individual information into the voice image or voice conversion data; and
an authentication server configured to generate a private key based on the feature vector and determine whether to extract the watermark and the individual information based on an authentication result.

2. The voice authentication system of claim 1, wherein the deep neural network model includes at least one of a long short term memory (LSTM) neural network model, a convolutional neural network (CNN) model, and a time-delay neural network (TDNN) model, and the feature vector is a D-vector.

3. The voice authentication system of claim 1, wherein the individual information is medical information including at least one of a medical code, patient personal information, medical record information corresponding to the feature vector.

4. The voice authentication system of claim 1, wherein the learning model server includes:
a frame generation unit configured to generate a voice frame for a predetermined time based on the voice information;
a frequency analysis unit configured to analyze a voice frequency based on the voice frame, and generate the voice image in time series by imaging the voice frequency; and
a neural network learning unit configured to extract the feature vector by causing the deep neural network model to learn the voice image.

5. The voice authentication system of claim 4, wherein the frequency analysis unit generates the voice image by applying the voice frame to a short time Fourier transform (STFT) algorithm.

6. The voice authentication system of claim 1, wherein the watermark server includes:
a watermark generation unit configured to generate and store the watermark corresponding to the feature vector;
a watermark embedment unit configured to embed the generated watermark and the individual information into a pixel of the voice image or the voice conversion data; and
a watermark extraction unit configured to extract the pre-stored watermark and the individual information based on the authentication result for the speaker.

7. The voice authentication system of claim 6, wherein the watermark embedment unit extracts an RGB value for each pixel of the voice image, calculates a difference between the RGB value and a total average RGB value, and embeds the watermark and the individual information into a pixel whose calculated difference is less than a threshold value.

8. The voice authentication system of claim 6, wherein the watermark embedment unit embeds the watermark and the individual information into a least significant bit (LSB) of the voice conversion data obtained by converting the voice information into a multidimensional array.

9. The voice authentication system of claim 1, wherein the authentication server includes:
an encryption generation unit configured to encrypt the feature vector to generate the private key corresponding to the feature vector;
an authentication comparison unit configured to compare the sameness between the encrypted feature vector and a feature vector of an authentication target; and
an authentication determination unit configured to determine whether authentication is successful for the speaker based on a comparison result, and determines whether to extract the watermark and the individual information.

10. The voice authentication system of claim 9, wherein the authentication comparison unit compares the sameness by applying the feature vector to an edit distance algorithm.

11. The voice authentication system of claim 9, wherein the authentication determination unit grants access and modification authority to the extracted voice information and individual information when authentication is successful, and outputs a warning signal for information forgery when authentication fails.

12. A voice authentication method comprising:
a voice collection step of collecting voice information obtained by digitizing a speaker's voice;
a learning model step of generating a voice image based on the collected voice information of the speaker, causing a deep neural network (DNN) model to learn the voice image, and extracting a feature vector for the voice image;
an encryption generation step of encrypting the feature vector to generate a private key corresponding to the feature vector;
a watermark generation step of generating and storing a watermark and individual information based on the private key;
a watermark embedment step of embedding the watermark and the individual information into a pixel of the voice image or voice conversion data;
an authentication comparison step of comparing the sameness between the encrypted feature vector and a feature vector of an authentication target;
an authentication determination step of determining whether authentication is successful for the speaker based on a comparison result, and determining whether to extract the watermark and the individual information; and
a watermark extraction step of extracting the watermark and the individual information that have been pre-stored based on an authentication result.

13. The voice authentication method of claim 12, wherein the learning model step includes:
a frame generation step of generating a voice frame for a predetermined time based on the voice information;
a frequency analysis step of analyzing a voice frequency based on the voice frame, and generating the voice image in time series by imaging the voice frequency;
a neural network learning step of causing the deep neural network model to learn the voice image; and
a feature vector extraction step of extracting the feature vector of the learned voice image.

14. The voice authentication method of claim 12, further comprising:
an authorization step of, when authentication is successful, granting access and modification authority to the extracted voice information and individual information; and
a forgery warning step of, when authentication fails, outputting a warning signal for information forgery.
